(19) United States
(12) Patent Application Publication
(10) Pub. No.: US 2005/0025862 A1
(43) Pub. Date: Feb. 3, 2005

(54) Multi-component dough

(75) Inventors: Mohamed M. Morad, Marshall, MN (US); Nagwa Zaki Sadek, Ypsilanti, MI (US); Mark Elliot Ingelin, Marshall, MN (US)

Correspondence Address: MERCHANT & GOULD PC, P.O. BOX 2903, MINNEAPOLIS, MN, 55402-0903, US

(73) Assignee: Schwan's Food Manufacturing, Inc.

(21) Appl. No.: 10/629,018

(22) Filed: Jul. 29, 2003

(51) Int. Cl. A23G 3/00

(52) U.S. Cl. 426/94

(57) ABSTRACT

A multi-component unbaked dough that can be baked into a unique structure having a soft moist interior region and a crispy, flaky exterior region.

### FIELD OF THE INVENTION

This invention relates generally to a food item comprising a multi-component or bi-component dough structure. The food can take a variety of styles including ready product, a potpie, pizza and other topped foods. The assembled food item can have dough with one, two or more multi-component dough layers. The food item can have a structure comprising two layer (bi-component) or multi-component raw dough, that is suitable for baking with a susceptor in a microwave oven or in conventional thermal or convection ovens to provide a cooked food article ready for serving. When cooked, the product has a pleasing flavor, texture and mouth-feel. The resulting food-article, made from multi-component dough, forms a structure with a crispy and flaky exterior crust and a tender porous interior structure. More particularly, the invention relates to crusts for pizzas and dough enrobed comestibles such as egg roll and pouch-type comestibles containing fillings such as sweet or savory compositions, including red meats, poultry, vegetables, cheese, eggs, fruits, custards and the like.

### BACKGROUND OF THE INVENTION

Convenience foods, that is, food items that require minimal preparation immediately prior to cooking and serving, have become increasingly popular. With the advent of the microwave oven and convection oven cooking, the time for baking or cooking many types of foods has been reduced. A challenge remains, however, to provide frozen or refrigerated convenience food items that can obtain an acceptable texture and flavor after microwave heating or baking in a conventional thermal or convection ovens. This is especially true of food items combining a dough structure that bakes into crust in contact with a moist topping or filling. Sweet or savory food in the form of appetizers, pizza or dough enrobed sandwiches have components that can reduce the crispy quality of baked dough. The moisture in the foods can migrate into the crust during cooking or serving and can cause the foods to become soft and soggy. Due to the difficult nature of the problems posed by such convenience foods, on the whole, microwave foods are often considered to be, at best, “utility” foods that do not match freshly prepared foods in taste or texture.

Ovens that directly contact food with thermal energy such as, household ovens, convection ovens, or restaurant or commercial ovens having a combination of heat sources, can heat food items to obtain a baking process. The thermal energy, when contacted with foods cause a physical change in the food, can reduce the water content in the food and often cause moisture to migrate through the food with well understood negative results for food portions that need to remain crispy and dry.

Similarly, a microwave oven operates on the general principle of an interaction between microwave energy and polar substances, such as water, contained in the item to be cooked. The interaction introduces energy into the polar substance that is released as heat that, in turn, cooks the item. Because the microwave oven acts on and heats the water containing portions of the item, heat is effectively applied only where sufficient moisture is present. In the case of food items having toppings or fillings containing a substantial amount of water, the item is cooked by heat generated from the topping or filling. Water can be converted to steam. The heat in the steam cooks the food item by transmitting the steam to other portions of the food. In the case of pizza, steam is emitted from the topping both into the oven cavity and through the pizza crust. In the case of a dough-enrobed item, steam is emitted from the filling through the enrobing dough. In both cases, the dough is baked, but the resulting crust can become undesirably soggy or gummy due to the action of the hot moisture on the product dough layer. Further, as steam passes through the crust, flavor elements can be removed by steam distillation, adversely affecting palatability. As a whole, the dough/crust technology has made little progress in making a successful crispy crust.

A variety of attempts have been made to develop crusts for convenience food items that can be baked in conventional ovens or in a microwave oven. On the whole the prior art efforts involve using fillings or toppings with previously baked crust structures. Yasosky et al., U.S. Pat. No. 5,520,937 disclose a batter coated on a dough-enrobed food item that is pre-fried in hot oil to partially cook the batter. The partially cooked item is then frozen and after sale is cooked to doneness using a microwave or conventional oven to provide a cooked item with a crust having a crisp texture. Bone et al., U.S. Pat. No. 4,283,424 disclose a dough for pizza crust having a baked upper crust made from conventional bread dough with a moisture content of 20 wt. % to 40 wt. % and a baked lower crust made from cracker-type material with a moisture content of less than 5 wt. %. After assembling a pizza from topping and baked upper and lower crust elements, the pizza is cooked to doneness without producing a soggy crust. Bernacchi et al., U.S. Pat. No. 4,744,994 discloses a method for preparing dough enrobed comestibles which retain crispiness during microwave or conventional oven cooking by enrobing the comestible with a first batter, frying, coating the first fried coating with a second coating and frying a second time. The dual, coating and frying, process seals moisture within the enrobed comestible. Dijkshoom, et al., U.S. Pat. No. 5,145,699 disclose a cooked enrobed food product having an intermediate layer from a cake material between an exterior crust layer and a filling. Cake batter is applied to sheeted bread dough and the result is folded around a filling and is then baked. The cake material is believed to control the migration of moisture from the filling to the dough layer. Dahle, U.S. Pat. No. 4,401,681 discloses forming a moisture impermeable barrier layer in situ between a high moisture phase, such as a pizza topping, and a low moisture baked crust phase by incorporating dextrin and a hydrophilic polysaccharide gelling agent into the high moisture phase. Dehydration of the surface of the high moisture phase promotes formation of a barrier layer having reduced moisture permeability. Forkner, U.S. Pat. No. 4,171,380 discloses an ice cream confection having a filling within an envelope of baked material. The envelope consists of a relatively thicker dough-backing layer interposed between the filling and a relatively thinner exterior dough layer. The backing layer provides a thermal barrier and a moisture barrier during cooking. Both Japanese patent application number JP 01003067 and JP 61260830 disclose baked pizza crust having a layered structure. The upper layer comprises pie dough and the lower layer comprises pizza dough. The pizza filling is place on the pie dough layer and the pie dough layer acts a barrier layer to migration of moisture from ingredients to the pizza dough layer.

None of the prior art baked crusts, or methods for preparing a dough composition food item, appear to be adequate to avoid prior art problems and to prepare a food comprising a filling and a crispy crust with a tender, porous and soft interior dough structure. Pre-fried materials, multi-layer baked crusts have been disclosed as a means to provide a crispy exterior crust. Barrier layers have been proposed for placement between the filling and the crust either to absorb moisture or to provide a physical barrier to the migration of moisture. These doughs and crusts and food items require relatively complex manufacturing processes often involving baking or frying as preliminary steps to providing a food item suitable for microwave cooking. Lastly, the product should be easily baked and during baking substantially retain moisture in the filling or topping and away from the exterior dough region.

A substantial need exists in the art to provide an uncooked or raw dough structure that can be readily manufactured, combined with a filling or topping, and baked into a high quality food. This quality baked food is characterized by a soft, bready interior and a crispy, flaky exterior even when assembled with moist components and toppings.

### SUMMARY OF THE INVENTION

The present invention provides an uncooked or raw two layer (bi-component) or multi-component dough structure for a filled or topped multi-component food item that when cooked obtains a tender, porous and soft interior dough structure adjacent a flaky, crisp exterior crust. Further the invention provides a dough multi-component product that is suitable for cooking by either microwave radiation or conventional thermal or convection ovens. The invention also provides a crust containing or a crust-enrobed food item that may be cooked to doneness in a single cooking step without preliminary cooking of the exterior layer. Still further the invention provides a crust that is adaptable to be filled with a variety of ingredients and, when cooked, will not become soggy or lose palatability. The food can comprise virtually any food that can include a baked dough layer. Such food includes pizza, calzone, sandwiches, pies, pot pies, meat pies, egg rolls, snack sandwiches, etc.

The multi-component dough of the invention comprises at least two substantially raw dough regions in a dough structure. The important character of the dough structure is that the dough has (1) at least one region that bakes to a tender, soft and moist layer and (2) at least one region that becomes crispy when cooked. The regions can be formed by at least two methods including (1) sheeting a dough and then treating the sheet to create a zone of different composition or (2) sheeting or pressing two separate and different layers and then combing the layers into a multi-component dough sheet. Means to adhere the layers into a single crust can be used creating at least three layers. The dough layers differ in composition such that the dough, after baking, will exhibit at least one crispy exterior and at least one soft bready interior region. Typical products include a crust having one crisp exterior and one tender layer. The invention also contemplates a three layer structure comprising a crisp layer, a tender layer and a crisp layer.

The multi-component dough structure of the invention comprises, at a minimum, a first layer and a second layer that differ in composition. Typically, the first or outer layer comprises full formula dough, while the second layer comprises dough that differs in at leas tone important ingredient, e.g., yeast, i.e., “an unleavened dough.” For the purpose of this patent application, the term outer dough when compared to the second or inner fully formulated inner dough, is substantially different in at least one important ingredient and is also often is different in thickness. Certain dough can be unleavened, while the formulated dough is leavened. Still other dough can differ in the amount of water in the formulated dough, other dough differ in the amount of fat used in the formulated dough. Overall, having a thinner exterior dough layer enhances the crispness of the exterior dough layer. The difference in formulation results in an outer first dough region that can crisp while baking, leaving the second inner region to become bready and soft. The layered structures of the invention can also be improved by introducing, between the first dough layer and the second dough layer, a barrier layer comprising a formulation that can reduce the tendency of moisture being transported from the formulated dough layer into the lean dough layer or in the opposite direction depending on formula and end use (or toppings). The barrier layer can also have an adhesive character to join the layers. The layered structures of the invention can be made by blending or formulating a fully formulated dough layer and a lean dough layer and then combining sheeted portions of each dough at the appropriate thickness.

In a second embodiment of the invention, a single dough formulation can be prepared and sheeted into a layer with a substantial thickness. One side of this two layered structure can then be processed to substantially change the moisture content of a region of the single layer. That region can be converted into a differing composition, typically by reduced moisture content. That layer can, for example, be hot pressed in the form of a large heated surface to cause a region of the single layer to lose moisture resulting in a region in the dough layer that, upon baking, becomes more crispy than the unheated region.

Alternatively, in another embodiment, a single dough formulation can be prepared, sheeted and combined into two layers of similar dough. One layer of this two layered structure can be processed to substantially change the moisture content of one layer, converting that layer into a different composition. That layer can be, for example, hot pressed in the form of a thinner layer causing the thinner layer to lose substantial quantities of moisture. The reduced moisture layer results in a dough that, when baked, becomes much more crispy than the thicker adjacent layer having substantially increased water content. Alternatively, a multi-component product can be made from a single dough with no sheeting step involved in this process. The first press stage divides the dough ball into two similar but co-joined shapes, while differentially heating what becomes the outside layer. The heat and pressure forms a thin outer dough sheet, reduces the moisture level of this layer and kills any yeast present. This again makes the layer of outer dough unleavened. To accomplish these functions the press is heated to at least 500° F., and compresses the dough for at least 5 seconds at 500 psi. The second press stage uses heat and pressure to form the multi-component dough.

In a preferred embodiment of the invention, fully formulated dough and an unleavened dough formulation are prepared. The second or inner formulated dough is sheeted into a layer of about 1 to 10 millimeters, or about 2 to 8 millimeters, while the first or outer dough is formulated into a layer of about 0.1 to 5 millimeters or about 0.1 to 0.9 millimeters. These sheeted layers are then combined to form a two layer structure. In one embodiment, each dough region is formed from a dough that is sheeted and laminated to form multiple layers (4 to 64 layers in the individual sheeted structures), the laminated sheets are then combined to form the two layer structure containing two laminated layers. The combined two layer structure can then be again sheeted (thickness reduced) to cause the two layer structure to fully adhere in the layers and to adjust the thickness of the first or outer layer to a dimension that can enhance the crispy structure. The multi-component product of the invention has two or more layers, at least two of the layers different in some aspect of formulation. One preferred embodiment of the invention is a pizza comprising a pizza topping on a layered dough structure.

For the purpose of this patent application, the term “crisp” indicates a dough that has a crust characteristic such that the dough, when measured for penetration using a Texture analyzer machine, has a rapidly rising force curve, measured by the high slope of the curve, reaches a failure plateau quickly and fails rapidly to a level that indicates a tender bready interior. For comparison, a steeper slope to the curve shows increased crispness. The term “tender” in this disclosure refers to a dough penetration measurement of the bready character at a level less than about 3000, about 1250 to 3000 grams just after baking. After a period of time the crust can increase in penetration force by as much as 50%. The term “toughness” indicates that a substantial amount of force is required over an extended period, a low slope of the penetration curve, to penetrate the dough and that, once penetrated; the dough does not fail and return to a low penetration level.

### DETAILED DISCUSSION OF THE INVENTION

The comestible food of the invention comprises unbaked at least two layers, bi-component, multi-component dough having a first outer crisp region or layer and a second inner tender region or layer. The comestible food has a topping or filling placed on the second or inner, tender layer. Such a product can be manufactured frozen or chilled. When prepared, the comestible food is then baked into a product that has a pleasing crispy exterior derived from the outer first layer, a soft and bready layer, derived from the second, inner layer, intermediate between the crispy exterior and the optional filling. The product is engineered such that the filling contents do not penetrate through the intermediate layer to reduce the quality or crispiness of the exterior layer.

A variety of formulations can be generally developed to obtain a bready second inner interior layer and a crispy first exterior layer. The food of the invention is manufactured in a process wherein the dough selected for the layers of the invention. A basic dough formulation can be selected and then adapted for the layers of the structures of the invention. Once formulated dough is selected a different formulation can be designated for use in the layered structures of the invention. Such a formulation is a blend of ingredients that is similar to the basic dough formulation but lacks or has one or more ingredients in a substantially reduced concentration. The lean formulation can have little or no active yeast leavening, substantially different, substantially greater, or little or no fat content, substantially different water content, etc.

A variety of dough process, formulation or recipes can be used and adapted for the layered dough structures. Once determined, the ingredients are typically added to the mixer at appropriate amounts and intervals and mixers are typically operated until the dough is well developed but not overworked. Dough is typically maintained at a temperature convenient for mixing and for sheeting. Once the dough is developed and at the right temperature, the dough is added to a sheeting line in portions appropriate for the equipment selected. The dough can be processed and then laminated by adding an appropriate laminating fat to the sheeted dough at an amount of about 5 to about 25 wt % based on the dough using conventional fat addition equipment. Typically, a conventional baker's margarine is used. The sheeting equipment is operated to reduce the thickness of the dough sheet and to produce a laminated dough sheet having 9 to 100 layers of the dough, preferably 7 to 40 layers of the dough, typically 8 to 40 layers of dough. Once fully laminated, the dough is reduced in thickness to obtain the appropriate weight per square inch to meet product tolerances as discussed below. One or more thickness reduction steps may be required to obtain a final dough weight. Once the dough is the appropriate thickness, the dough is then split, cut or processed into the base and sealing layer portions.

The layers are combined in the final product by adhering the perimeter or the entire surface of the layers to form a seal in the layered food. At this stage in the process, a light water mist can be applied to a sheet to ensure proper sealing of one layer to another layer. A barrier layer can be inserted into the layered structure that can act as a moisture barrier and as an adherent layer. The layers can be then placed one over the other. Power driven equipment is then used to compress and adhere the layers. Power driven pressing rollers or other equipment can apply sufficient pressure with sufficient numbers of pressing steps to ensure that the layers are adhered sufficiently to ensure the food is mechanically stable during subsequent baking and consumer reheating.

The filling is deposited on the surface of the layered structure, a filling depositing applicator is used to place the filling on the dough base layer.

The process discussed above can be used to prepare single portions of the food or can be used to prepare a long sheet of dough and filling that can be subsequently sealed and cut into individual serving size portions. However, the overall process is identical having one major difference that the dough portions are cut prior to assembly for the individual single portions and in the continuous manufacture of sheeted laminated material, the individual portions are then cut after sealing.

The product can be then quick frozen at a temperature substantially below the freezing point of water for sufficient time to ensure that the interior of the filling is frozen before wrapping. The product is then combined with an appropriate shaped susceptor device and the pizza portion and susceptor are then shrink-wrapped with packaging designed to maintain the overall shape of the product and to protect the triangular apexes from breaking or other damage.

The food can be baked for a period of time of about 10 to 40 minutes at 350° F. to 550° F. After completely cooking and leaving a pleasing golden brown appearance, a crispy exterior and a soft and bready interior.

An embodiment of the invention comprises multi-component pizza dough where in the difference between the dough layers resides in a combination of leavening, thickness and the amount of water with respect to the flour used to manufacture the dough layers. In the crispy first outer layer the water content is less than the water content of the inner layer. The water absorption of the outer layer is around 45% while the inner layer is 55%.

In one embodiment of the invention comprises a dough multi-component dough in a shaped configuration for a comestible having a first dough layer having a water content of at least about 43% water absorption and a second dough layer having a water content less than 53% water absorption wherein the multi-component dough has a shape configured to receive a filling in contact with the second dough layer to form a comestible and the comestible is suitable for baking to provide a baked item having a crisp, flaky first crust outer layer corresponding to the first dough layer and a tender, soft second crust inner layer corresponding to the second dough layer.

Another embodiment of the invention comprises multi-component dough where in the difference between the dough layers resides in the amount of fat with respect to the flour used to manufacture the dough layers. Fat in this application can be used in the form of oil, butter, margarine, lard, shortening or other common fat sources. In the crispy first layer the fat content can be greater than the fat content of the second inner layer. The layers, however, can be made with the first outer layer having less fat than the second inner layer. Generally, the fat content of the exterior layer is more than twice the fat content of the inner layer. In one embodiment of the invention comprises a dough multi-component dough in a shaped configuration for a comestible having a first dough layer having a shortening content of at least about 13% and a second dough layer having a shortening content less than 5 wt. % wherein the multi-component dough has a shape configured to receive a filling in contact with the second dough layer to form a comestible and the comestible is suitable for baking to provide a baked item having a crisp, flaky first crust outer layer corresponding to the first dough layer and a tender, soft second crust inner layer corresponding to the second dough layer.

According to the invention, the first dough layer may be folded upon itself at least once to form a lamination layer and preferably at least 4 times and most preferably at least 64 times or more. The overall thickness of the multi-component dough of the invention can range from about 3 mm to about 3 cm in an uncooked condition after the layers are combined. In general the ratio of thickness of the first outer, crisp layer to that of the second inner tender layer is that the first layer is about 0.05 to about 0.5:1 ratio of thickness of the first layer to the second layer.

In the manufacture of the multi-component layer of the invention, a barrier material can be placed between the layers to improve the crispness of the exterior. Such separated layers comprise a material layer that can reduce the rate of water transmission or bar the transmission of water from one layer of the multi-component dough into the other. The barrier reduces the water transmission through the boundary between the full formula dough and the unleavened dough. The barrier layer can also show some adhesive character. The adhering barrier material can take at least three forms. The forms include a water resistant carbohydrate layer (gelatinized starch in an aqueous solution or dispersion), a proteinaceous layer (e.g. melted cheese, egg white) or a hydrophobic layer of solid fat (high melt point fat chips).

The first outer crispy and second inner tender dough layers can be separately sheeted to provide dough layers having a thickness depending on the intended use for the multi-component dough. The thickness of the first dough layer can be selected independently from the thickness of the second. The thickness of a layer can be is 0.5 mm to 3 mm and preferably 1 mm to 2 mm. The thickness of the second dough layer is 0.5 mm to 3.5 mm and preferably 1 mm to 3 mm. If the multi-component dough is used as a pizza crust, the thickness of the first dough layer is 0.5 mm to 1 mm, and the thickness of the multi-component dough is 2.5 mm to 3.5 mm. If the multi-component dough is used to enrobe a filling, the thickness of the first dough layer is 0.4 mm to 0.6 mm, and the thickness of the multi-component dough is 0.4 mm to 0.6 mm.

The dough layers can typically be wheat flour based compositions and may include leavening agents, water, and flavoring agents such as salt, sugar, and dough conditioners as well as shortening.

The multi-component product when cooked obtains a crisp exterior and a light bready interior from the formula and the processing of the dough materials. The tenderness, crispness and toughness of a cooked, baked crust can be measured using texture analyzer equipment. The equipment can quantify the tenderness, crispness or toughness of a crust in units of gm (grams), gm-sec⁻¹ (grams per second) and gm-sec (gram seconds) by an analysis of the forces exerted by a probe. Tenderness typically is a measure of the force required to penetrate the product with the machine probe, but mimics the force needed to bite through the product. Crispness is a measurement of the steepness slope of the force curve (Force Gradient in gm-sec) needed to penetrate the crust. In other words, as the crispy crust is bitten, the slope of the penetration curve is very steep, greater than 300 gm-sec⁻¹ or 550 gm-sec⁻¹, reaches a failure point very quickly, but fails at a relatively defined level. A less crispy crust will have a less steep curve that reaches a lesser maximum. The goal is to maximize the slope of the curve relating to the first outer layer with respect to the second inner layer and to comparative products. An area under the force curve (Area of Force Curve in gm-sec) that indicates that a great deal of force, greater than 8000 gm-sec) is needed typically shows toughness in a crust. This indicates that a great deal of time and force is required to chew (penetrate) tough dough. A tender dough is typically less than 5500 gm-sec. (particularly at some time, +20 minutes, after baking), or less than 3000 gm-sec. within 5 minutes of baking.

In measuring these crusts characteristics, the equipment is TA.XT2 Texture analyzer. The equipment can be obtained from Stable Micro System Company and is available for crust evaluations in a variety of product configurations and dough formulations. Food scientists have known for many years that it is difficult to obtain both crispness and tenderness in the same product without substantial toughening in a microwave cooked offering. We have found that the borderline between toughness and tenderness is about 3000 g measured within 5 minutes after the conclusion of baking. Greater than 3000 g, in some dough, 20 minutes or more after baking, greater than 4500 g., indicates a substantially toughened dough, while substantially less than 3000 g indicates clear, tender dough character. A secondary measurement of toughness is the area under the force curve. It can be readily understood that, as the area under the force curve increases, that the force required to penetrate and continue penetrating the baked crust stays high with increasing area. Accordingly, a large area under the force curve, typically greater than 6500 gm-sec. or greater than 8000 gm-sec. indicates a toughened crust. Either the overall force gradient of the curve measured from the initiation of force on the crust to peak force or by measuring the slope of the force curve at or just before penetration, provides a characterization of crust crispness. We have found that an overall force gradient, measured within 5 minutes of baking, greater than about 300 gm-sec-⁻¹ in the overall gradient or greater than about 550 gm-sec⁻¹ near peak force is indicative of a crispy crust. This crispiness must be combined with a measurement of deftness to indicate a quality crust. This measurement also, in conjunction with a crisp measurement, indicates the high quality dough required in the invention. To date, the dough that is formulated for microwave oven cooking, all have tenderness values substantially greater than 3000 gm and are noticeably tough on eating.

The dough layers may be formed to a desired size and shape and overlaid to provide a dough multi-component suitable for forming a multi-component food item. An intermediate coating may be applied between the dough layers to improve adhesion between the layers. The major goals to be achieved are taste and texture, reduced water content, tomato sauce or paste content and the blend of cheese, spices, and optional meat ingredients completing the filling. Typical tomato concentrates, pastes or sauces are used as a base component combined with other solid ingredients such as cheese, meats, prepared meats and herbs. Ingredients that can complete the pizza sauce components include thickeners such as starches, non-fat dry milk, oil, chopped vegetables and other conventional ingredients. Meat components of the filling include conventional pizza ingredients including sausage, Italian sausage, pepperoni, ham, ground beef, chicken portions and other conventional meat ingredients formed in convenient product sizes for use in filling recipes. The cheese component for use in the pizza portions of the invention includes mozzarella cheeses, jack cheeses, American cheese, Swiss cheese and other common cheese products.

The pizza of the invention can be made in a variety of culinary styles including an Italian style, a Vegetarian style, a Southwest style, a Mexican style, a Tex-Mex style, a Greek style, a Hawaiian style, and other common food styles. An Italian style food typically comprises tomato sauce, pepperoni or Italian sausage, mozzarella cheese and Italian seasonings including oregano, garlic, etc. A Vegetarian style food typically comprises tomatoes, onions, mushrooms, green or black olives and seasonings. A Southwest style, Tex-mex or Mexican style food typically comprises tomatoes, chiles, onions, jack cheese, shredded beef or chicken, cilantro and other common flavorings. A Greek style food typically comprises feta cheese, cucumbers, onions, cream fillings, lamb and typical gyros-type foods. A Hawaiian style food typically comprises ham, pineapple, macadamia nuts, etc.

The invention is also directed to a multi-component food item comprising an edible filling enrobed in the aforementioned multi-component dough. It is understood that “enrobed” envisages food items having the filling partly or wholly surrounded by the multi-component dough. The filling portion contacts the second dough layer that forms an interior dough layer for the multi-component food item and the first dough layer forms an exterior layer. When the multi-component dough wholly surrounds the filling, the food item is a sandwich or pouch-type item. When the multi-component dough partly surrounds the filling, the food item is an open-face type product such as a pizza, pastry, partially enrobed sausage and the like. The multi-component food item can be frozen or otherwise preserved for cooking at a latter time. The food item finally is cooked or baked in a microwave or conventional oven to provide a finished, ready to eat product.

The above discussion sets forth the basic discussion of the layered technology relating to the food products of the invention. The following experimental section sets forth a variety of specific embodiments of the invention.

### Experimental

The following examples of layered food technology exemplifies the general technology discussed above. The following examples include a two layer or bi-component dough and a two layer dough or multi-component dough including a barrier layer between the first layer and second layer. The following examples further includes a best mode.

### EXAMPLE 1

INNER DOUGH

| INGREDIENT | GRAMS |
|---|---|
| Flour | 100 |
| Water | 50 |
| Salt | 1 |
| Sugar | 2 |
| Oil (7% mono-diglyceride) | 12 |
| Yeast (instant active) | 0.5 |
| Single action BP | 1.5 |
| Double action BP | 1 |
| Non diastatic malt | 0.5 |
| Garlic powder | 1 |
| Bread flavor | 1 |
| Inactive yeast | 0.5 |
| TOTAL | 179 |

Sheet INNER layer to 2.5 mm. Thickness.

OUTER DOUGH

| INGREDIENT | GRAMS |
|---|---|
| Flour | 100 |
| Water | 45 |
| Salt | 1 |
| Sugar | 2 |
| Shortening (all purpose) | 15 |
| VX200 | 2 |
| Non diastatic malt | 0.5 |
| Inactive yeast | 0.5 |
| TOTAL | 166 |

Sheet OUTER layer to 0.5 mm in thickness. Brush with a starch/water dispersion and then assemble the two layers to 3.0 mm thickness.
Filling weight=85 gr. Dough weight=100 to 105 gr. Total weight=185 to 190 gr. or 6.4 to 6.8 oz. Filling/dough ratio=44/56 to 42/58 Add 5.0 gr. of topping and about 2-3 gr. of spray for color.

### EXAMPLE FILLING FOR EXAMPLES

CHEESE FILLING

| | GRAMS PER |
|---|---|
| | OR GRAMS |
| INGREDIENT | FLOUR |
| Parmesan (hydrated) | 2 |
| Mozzarella | 3 |
| Cheddar | 3 |

SAUCE FILLING

| INGREDIENT | PERCENT |
|---|---|
| Water | 65.51 |
| Tomato paste | 25.00 |
| Oil | 1.31 |
| Salt | 1.08 |
| Clearjel II | 1.72 |
| Granulated onion | 0.37 |
| Dextrose | 1.39 |
| Textaid | 0.70 |
| Sugar | 1.47 |
| Garlic powder | 0.22 |
| Citric acid | 0.18 |
| Beet powder | 0.03 |
| Ground thyme | 0.01 |
| Dehydrated Romano Cheese | 0.29 |
| Ground black pepper | 0.15 |
| Ground paprika | 0.21 |
| Whole oregano | 0.26 |
| Whole basil | 0.11 |

1. Weigh water into mixing bowl.
2. Add oil and mix 30 seconds.
3. Add spice blend and mix 30 seconds.
4. Scrape bowl and mix 30 seconds.
5. Add tomato paste and mix 4 minutes.
6. Scrape bowl as needed.

### EXAMPLE 2

INNER DOUGH

| INGREDIENT | GRAMS |
|---|---|
| Flour | 2000 |
| Water | 50 |
| Salt | 10 |
| Sugar | 20 |
| Oil (7% mono-diglyceride) | 100 |
| Yeast | 5 |
| Double action BP | 10 |
| Non diastatic malt | 5 |
| Garlic powder | 10 |
| Sour dough flavor | 10 |
| Inactive yeast | 5 |
| Parmesan | 20 |
| Mozzarella | 30 |
| Cheddar | 30 |
| TOTAL | 175.5 |

OUTER DOUGH

| INGREDIENT | GRAMS |
|---|---|
| Flour | 1000 |
| Water | 450 |
| Salt | 10 |
| Sugar | 20 |
| Shortening | 200 |
| VX200 | 20 |
| Non diastatic malt | 5 |
| Inactive yeast | 5 |
| TOTAL | 171 |

### EXAMPLE 3

INNER DOUGH

| INGREDIENT | GRAMS |
|---|---|
| Flour | 100 |
| Water | 47 |
| Salt | 1 |
| Sugar | 2 |
| Oil (7% mono-diglyceride) | 12 |
| Yeast (instant active) | 0.8 |
| Single action BP | 1.5 |
| Double action BP | 1 |
| Non diastatic malt | 0.5 |
| Garlic powder | 1 |
| Bread flavor | 1 |
| Inactive yeast | 0.5 |
| Parmesan (hydrated) | 2 |
| Mozzarella | 3 |
| Cheddar | 3 |
| TOTAL | 174.2 |

Sheet INNER layer to 2.1 mm. Thickness.

OUTER DOUGH

| INGREDIENT | GRAMS |
|---|---|
| Water | 45 |
| Salt | 1 |
| Sugar | 2 |
| Shortening | 15 |
| VX200 | 2 |
| Non diastatic malt | 0.5 |
| Inactive yeast | 0.5 |
| TOTAL | 171 |

Sheet OUTER layer to 0.6 mm thickness. Brush with a starch/water dispersion and then assemble the two layers to 2.5 mm thickness. Filling weight=75 gr. Dough
weight=100 to 110 gr.
Total weight=175 to 185 gr. or 6.2 to 6.5 oz.
Filling/dough=43/57 to 40/60

### EXAMPLE 4

INNER DOUGH

| INGREDIENT | GRAMS |
|---|---|
| Flour | 100 |
| Water | 52 |
| Salt | 1 |
| Sugar | 12 |
| Oil (7% mono-diglyceride) | 12 |
| Yeast (instant active) | 0.6 |
| Single action BP | 1.5 |
| Double action BP | 1 |
| Non diastatic malt | 0.5 |
| Garlic powder | 1 |
| Bread flavor | 1 |
| Inactive yeast | 0.5 |
| Parmesan (hydrated) | 2 |
| Mozzarella | 3 |
| Cheddar | 3 |
| TOTAL | 182 |

Sheet INNER layer to 2.1 mm. Thickness.

OUTER DOUGH

| INGREDIENT | GRAMS |
|---|---|
| Flour | 100 |
| Water | 45 |
| Salt | 1 |
| Sugar | 2 |
| Shortening | 15 |
| VX200 | 2 |
| Non diastatic malt | 0.5 |
| Inactive yeast | 0.5 |
| TOTAL | 166 |

Sheet OUTER layer to 0.6 mm. Thickness. Brush with a starch/water dispersion and then assemble the two layers to 2.5 mm thickness.
Filling weight=75 gr. Dough weight=100 to 110 gr. Total weight=175 to 185 gr. or 6.2 to 6.5 oz. Filling/dough=43/57 to 40/60

### EXAMPLE 5

INNER DOUGH

| INGREDIENT | GRAMS |
|---|---|
| Flour | 1000 |
| Water | 540 |
| Salt | 10 |
| Sugar | 20 |
| Garlic powder | 10 |
| LCR | 10 |
| Non diastatic malt | 5 |
| Single action BP | 15 |
| Double action BP | 10 |
| Mozzarella | 30 |
| Cheddar | 30 |
| Shortening | 20 |

OUTER DOUGH

| INGREDIENT | GRAMS |
|---|---|
| Flour | 1000 |
| Water | 560 |
| Salt | 5 |
| Sugar | 20 |
| Garlic powder | 10 |
| LCR | 10 |
| Non diastatic malt | 3 |
| Single action BP | 25 |
| Rice flour | 20 |

BARRIER

| INGREDIENT | GRAMS |
|---|---|
| Flour | 1000 |
| Water | 480 |
| Salt | 10 |
| Sugar | 20 |
| VX200 | 20 |
| Shortening | 150 |

### EXAMPLE 6

INNER DOUGH

| INGREDIENT | GRAMS |
|---|---|
| Flour | 1000 |
| Water | 530 |
| Salt | 10 |
| Sugar | 20 |
| Fat 5% | 40 |
| VX200 | 10 |
| IADY | 5 |
| Single action BP | 15 |
| Double action BP | 10 |
| Non diastatic malt | 5 |
| Inactive yeast | 15 |
| Garlic powder | 10 |
| Parmesan | 20 |
| Cheddar | 30 |
| Mozzarella | 30 |

Inner Dough
1. Mix all ingredients for 2 minutes and at a higher rate for 3 minutes.

2. Sheet 1 part of dough to 2.5 mm and the other part to 0.6 mm.

OUTER DOUGH

| INGREDIENT | GRAMS |
|---|---|
| Flour | 1000 |
| Water | 450 |
| Salt | 10 |
| Sugar | 20 |
| Fat 5% | 150 |
| VX200 | 20 |

Outer Dough
1. Mix all ingredients at speed 1 for 2 minutes and then speed 2 for 2 minutes.
2. Sheet 1 part of dough to 0.6 mm and the other part at 0.6 mm.
   Inner and Outer Doughs
1. Take inner dough at 2.5 mm and outer dough at 0.6 mm, put mixture of (water, glaze, maillose) in between the doughs and sheet at 3.1 mm once and then once at 2.9 mm. Dock before sheeting together.
2. Take inner dough at 0.6 mm and outer dough at 0.6 mm, put mixture of (water, glaze, malose) in between the doughs and dock, then sheet once at 1.2 mm.

3. Put the 0.6 mm and 2.5 mm dough into pan and spray with glaze mixture, place the filling into pan and then place 0.6 mm and 0.6 mm over top and press sides down/and cut 5.5 inches around and lift sides up, second spray top with glaze mixture. Then make ⅜ of end inch hole on top. Then place in freezer.

GLAZE MIXTURE

| INGREDIENT | GRAMS |
|---|---|
| Glaze | 18 |
| Water | 282 |
| Maillose | 40 |

FILLING MIXTURE

| INGREDIENT | GRAMS |
|---|---|
| Pepperoni | 450 |
| Sauce | 750 |
| Cheese | 1200 |

* 85 grams in each stuffed pizza

60 dough/40 filling

ZESTY MIX

| INGREDIENT | GRAMS |
|---|---|
| Parmesan | 200 |
| Oregano | 5 |
| Salt | 10 |

### Susceptor

Tray with Lid

1. Open faced tray
2. Cardboard sleeve
3. Paper sleeve

The above discussion, recipes, process information handed disclosure provides a basis for understanding the meets and bounds of the invention and discloses a preferred embodiment. However, since many embodiments of the invention can be made without departing from the spirit and scope of the invention, the invention resides in the claims hereinafter appended.

1. A comestible food comprising a multi-component dough, the multi-component dough comprising:
(a) a first unleavened dough planar region;
(b) a second yeast leavened dough planar region; and
(c) a filling or topping in contact with the first region;
wherein the first region differs from the second region in moisture content, fat content combinations thereof and wherein the multi-component dough is suitable for baking to provide a baked item having a crisp, flaky exterior layer derived from the second layer and a tender, soft inner layer derived from the first layer.

2. The comestible food of claim 1, wherein the second region has a moisture content of about 50 to 55 wt %, the first region has a moisture content of about 30 to 45 wt % and the ratio of thickness of the first region to the second region is about 1:0.5 to 0.05.

3. The comestible food of claim 1, The second region has a fat content of about 2 to 20 wt %, the first region having a fat content of about 5 to 25 wt % and the ratio of thickness of the second region to the first region is about 1:0.5 to 0.05.

4. The comestible food of claim 1 wherein the second region comprises 50 to 55% water and about 2 to 20 wt % fat and the first region comprises about 30 to 45% water and about 5 to 25 wt % fat and the ratio of thickness of the second region to the first region is about 1:0.5 to 0.05.

5. The baked comestible food comprising the product of baking the multi-component dough of claim 1.

6. The multi-component dough for a baked crust of claim 1 wherein the food is frozen and the first dough region comprises a sheeted layer and the second dough region comprises a sheeted layer.

7. The multi-component dough for a baked crust of claim 3 wherein the second dough layer comprises a moisture content of about 50 to 55 wt % and a fat content of about 2 to 20 wt % and the first dough layer comprises a moisture content of about 30 to 45 wt % and a fat content of about 5 to 25 wt %.

8. The multi-component dough for a baked crust of claim 1 wherein the second dough region is about 1 to 3.5 mm thick.

9. The multi-component dough for a baked crust of claim 1 wherein the first dough region is about 0.3 to 0.6 mm thick.

10. The multi-component dough for a baked crust of claim 1 wherein the second dough region and the first dough region comprise a formulation comprising wheat flour.

11. The multi-component dough for a baked crust of claim 1 wherein the multi-component comprises an edible barrier layer between the first dough region and second dough region.

12. The multi-component dough of claim 1 wherein the edible layer is an adhesive layer.

13. The multi-component dough of claim 1 wherein the edible layer is a moisture barrier layer.

14. The multi-component dough of claim 12 wherein an adhesive is selected from a group consisting of water and an aqueous dispersion of gelatinized starch.

15. The multi-component dough of claim 1 wherein the first dough layer comprises a laminated layer having four or more laminations and a fat content of about 5 to 25 wt %.

16. The multi-component dough of claim 15 wherein fat is selected from the group consisting of butter, margarine, vegetable oil, shortening, lard or mixtures thereof.

17. A comestible food comprising a multi-component dough, the multi-component dough comprising:
(a) a first lean formulation dough planar region having a thickness less than 0.8 mm;
(b) a second formulated dough planar region having a thickness of greater than about 1 mm;
wherein the first region differs from the second region in moisture content, fat content combinations thereof and wherein the multi-component dough is suitable for baking to provide a baked item having a crisp, flaky exterior layer derived from the first layer and a tender, soft inner layer derived from the second layer.

18. The comestible food of claim 17 wherein the second region has a moisture content of 50 to 55 wt %, the first region has a moisture content of about 30 to 45 wt % and the ratio of thickness of the second region to the first region is about 1:0.5 to 0.05.

19. The comestible food of claim 17 wherein the second region has a fat content of 2 to 20 wt %, the first region has a fat content of about 5 to 25 wt % and the ratio of thickness of the second region to the first region is about 1:0.5 to 0.05.

20. The comestible food of claim 17 wherein the first region comprises an unleavened layer and the ratio of thickness of the second region to the first region is about 1:0.5 to 0.05.

21. The comestible food of claim 17 wherein the second layer comprises a yeast leavened layer and the first layer is substantially free of leavening.

22. The baked comestible food multi-component dough comprising the product of baking the multi-component dough of claim 1.

23. The baked comestible food multi-component dough of claim 1 wherein the food is frozen and the first dough region comprises a layer and the second dough region comprises a layer.

24. The baked comestible food multi-component dough of claim 18 wherein the second dough layer comprises a moisture content of about 50 to 55 wt % and a fat content of about 2 to 20 wt % and the first dough layer comprises a moisture content of 30 to 45 wt % and a fat content of 5 to 25 wt %.

25. The baked comestible food multi-component dough of claim 21 wherein the thickness ratio of the first dough region to the second dough region is about 0.05 to 0.5:1.

26. The baked comestible food multi-component dough of claim 17 wherein the second dough region is about 1 to 3.5 mm thick.

27. The baked comestible food multi-component dough of claim 17 wherein the first dough region is about 0.3 to 0.6 mm thick.

28. The baked comestible food multi-component dough of claim 17 wherein both the first dough region and the second dough region comprise a formulation comprising wheat flour.

29. The baked comestible food multi-component dough of claim 17 wherein the multi-component dough comprises an edible layer between the first dough region and the second dough region.

30. The multi-component dough of claim 17 wherein the edible layer is an adhesive layer.

31. The multi-component dough of claim 17 wherein the edible layer is a moisture barrier layer.

32. The multi-component dough of claim 30 wherein an adhesive is selected from a group consisting of water and gelatinized starch.

33. The multi-component dough of claim 17 wherein the first dough layer comprises a laminated layer having four or more laminations and a fat content of about 5 to 25 wt %

34. The multi-component dough of claim 33 wherein fat is selected from the group consisting of butter, margarine, vegetable oil, shortening, lard or mixtures thereof.

35. A comestible food item comprising:
(a) a multi-component dough comprising:
(i) a first unleavened dough layer having a thickness less than about 0.9 mm; and
(ii) a second yeast leavened dough layer having a moisture content of at least about 50 wt % having a thickness of greater than 1 mm;
(b) a filling portion in contact with the second dough inner layer; wherein the multi-component food item is suitable for baking to provide a baked item having a crispy and flaky crust outer layer corresponding to the first dough layer and a soft inner layer corresponding to the second dough layer.

36. The multi-component food item of claim 35 wherein the multi-component dough layer enrobes the filling portion to form a pouch-type sandwich food item.

37. The multi-component food item of claim 35 wherein the multi-component dough layer forms a pizza crust and the filling portion forms a pizza topping in contact with the second dough layer.

38. The baked comestible food comprising the product of baking the multi-component dough of claim 35.

39. The multi-component dough for a baked crust of claim 35 wherein the food is frozen and the second dough region comprises a layer and the first dough region comprises a layer.

40. The multi-component dough for a baked crust of claim 35 wherein the second layer comprises a moisture content of about 50 to 55% and a fat content of about 2 to 20%.

41. The multi-component dough for a baked crust of claim 35 wherein the first dough layer comprises a moisture content of less than about 45%.

42. The multi-component dough for a baked crust of claim 35 wherein the thickness ratio of first dough region to the second dough region is about 0.05 to 0.5:1.

43. The multi-component dough for a baked crust of claim 35 wherein the second dough region is about 1 to 3.5 mm thick.

44. The multi-component dough for a baked crust of claim 35 wherein the first dough region is about 0.3 to 0.6 mm thick.

45. The multi-component dough for a baked crust of claim 35 wherein the second dough region and the first dough region comprise a formulation comprising wheat flour.

46. The multi-component dough for a baked crust of claim 35 wherein the multi-component dough comprises an edible layer between the first dough region and the second dough region.

47. The multi-component dough of claim 35 wherein the edible layer is an adhesive layer.

48. The multi-component dough of claim 35 wherein the edible layer is a moisture barrier layer.

49. The multi-component dough of claim 48 wherein an adhesive is selected from a group consisting of water and an aqueous dispersion of gelatinized starch.

50. The multi-component dough of claim 35 wherein the first dough layer comprises a laminated layer having four or more laminations and a fat content of about 2 to 20%.

51. The multi-component dough of claim 50 wherein fat is selected from the group consisting of butter, margarine, vegetable oil, shortening, lard or mixtures thereof.

52. A method of making a comestible food comprising a multi-component dough, the method comprising:
(a) forming a structure having at least:
(i) a first formulation dough planar region having a thickness less than 0.8 mm; and
(ii) a second formulated dough planar region having a thickness of greater than about 1 mm;
(b) heating the structure to a temperature sufficient to change water content, by at least 1 wt.-%, in a region forming the multi-component dough;
wherein in the multi-component dough the first region differs from the second region in moisture content, fat content combinations thereof and wherein the multi-component dough is suitable for baking to provide a baked item having a crisp, flaky exterior layer derived from the first layer and a tender, soft inner layer derived from the second layer.

53. The method of claim 52 wherein the structure is heated to a temperature of at least 170° F.

53. The method of claim 52 wherein the structure is heated with a metallic planar heated surface.

54. The comestible food of claim 53 wherein the second region has a moisture content of 50 to 55 wt %, the first region has a moisture content of about 30 to 45 wt % and the ratio of thickness of the second region to the first region is about 1:0.5 to 0.05.

55. The method of claim 52 wherein the second region has a fat content of 2 to 20 wt %, the first region has a fat content of about 5 to 25 wt % and the ratio of thickness of the second region to the first region is about 1:0.5 to 0.05.

56. The method of claim 52 wherein the first region comprises an unleavened layer and the ratio of thickness of the second region to the second region is about 1:0.5 to 0.05.

57. The method of claim 52 wherein the second layer comprises a yeast leavened layer and the first layer is substantially free of leavening.

58. The method of claim 52 wherein the second dough layer comprises a moisture content of about 50 to 55 wt % and a fat content of about 2 to 20 wt % and the first dough layer comprises a moisture content of 30 to 45 wt % and a fat content of 5 to 25 wt %.

59. The method of claim 52 wherein the thickness ratio of the first dough region to the second dough region is about 0.05 to 0.5:1.

60. The method of claim 52 wherein the second dough region is about 1 to 3.5 mm thick.

61. The method of claim 52 wherein the first dough region is about 0.3 to 0.6 mm thick.

62. The method of claim 52 wherein the multi-component dough comprises an edible layer between the first dough region and the second dough region.

63. The method of claim 52 wherein the edible layer is a moisture barrier layer.
